(19) United States
(12) Patent Application Publication
(10) Pub. No.: US 2019/0021826 A1
(43) Pub. Date: Jan. 24, 2019

(54) METHOD AND SYSTEM FOR INTERDENTAL CLEANING

(71) Applicant: RIMVYDAS TVERAS, PALOS HILLS, IL (US)

(72) Inventor: RIMVYDAS TVERAS, PALOS HILLS, IL (US)

(21) Appl. No.: 16/035,965

(22) Filed: Jul. 16, 2018

Related U.S. Application Data
(60) Provisional application No. 62/533,725, filed on Jul. 18, 2017.

(51) Int. Cl. A61C 15/04

(52) U.S. Cl. CPC A61C 15/046; A46B 2200/108; A61C 15/043

(57) ABSTRACT

Disclosed is a method and system for interdental cleaning comprising an interdental cleaning tool and a pad adapted to be held in a semi-folded configuration between the thumb and fingers of one hand, said pad having an absorbent side and a barrier side, said absorbent side containing a liquid and adapted to washing and wetting simultaneously both opposite sides of the active portions of an interdental cleaning tool, said method comprising the following steps: (1) washing simultaneously both opposite sides of the active portions of an interdental cleaning tool with the pad; (2) using the interdental cleaning tool in an interdental space; (3) repeating steps (1) and (2), as many times as desired, for all of the interdental spaces and behind the molars of the mouth.

### CROSS-REFERENCE TO RELATED PATENT APPLICATIONS

This application claims the benefit of provisional patent application No. 62/533,725 filed Jul. 18, 2017 by the present inventor.

### FEDERALLY SPONSORED RESEARCH

Not Applicable

### SEQUENCE LISTING

Not Applicable

### FIELD OF THE INVENTION

The present invention is in the field of oral hygiene. More specifically, the present invention relates to the field of interdental cleaning.

### BACKGROUND OF THE INVENTION

Oral hygiene is the practice of keeping one's mouth clean and free of disease and other problems, such as bad breath. Most oral hygiene consists of regular tooth brushing, cleaning between the teeth, and cleaning of the tongue. It is important that oral hygiene be carried out on a regular daily basis to enable prevention of not only dental disease, but also of an ever-growing list of systemic diseases as well, such as cardiovascular disease, bacterial pneumonia, diabetes mellitus, low birth weight, and even osteoporosis and some cancers. The most common types of dental disease are tooth decay and gum diseases, including gingivitis and periodontitis.

Cleaning between the teeth is called interdental cleaning and is as important as tooth brushing. This is because a toothbrush cannot reach between the teeth and therefore only cleans about two-thirds of the tooth surfaces. There have been many tools to clean between the teeth, including floss, flosspicks, interdental brushes, water jets, and air flossers. Unfortunately, each has had its shortcomings, and failed to provide many users with satisfactory outcomes.

Flossing with dry string floss is the preferred method of interdental cleaning prescribed by most dental hygienists and oral health professionals. When done daily and properly, flossing removes the majority of mouth debris, consisting of food particles. However, when it comes to removing plaque and biofilm, it is not as effective as one would like. The reason is easy to understand. Dragging a string over a tooth surface may have the effect of disrupting some early stages of biofilm development, but cannot entirely remove it from the mouth. One can draw a comparison of attempting to wash a sinkful of dirty dishes without water. It is immediately seen as an impossible task.

Traditional flossing, e.g., flossing with dry string floss, is inconvenient, unpleasant, time consuming, and requiring good manual dexterity. It is a difficult task for most people, and nearly impossible for many, especially children and the elderly. Having both hands tethered to a piece of floss wound tightly around two opposite fingers while attempting to maneuver a stretched portion of floss deep inside one's mouth, and making sure to wrap around each tooth, including the back sides of hard-to-reach molars, and then to drag the tight floss across the surface, from the gum line to the top, is enough to discourage even the most determined practitioner of good oral hygiene.

The facts speak for themselves. Efforts of dental professionals to encourage and prescribe flossing as a required part of everyone's daily oral care, throughout many decades, have yielded dismal results. The American Dental Association says most dentists would guess that the percentage of daily flossers is less than 30 percent, maybe as low as 10 percent. Please see article: “How Many Americans Floss Their Teeth?” U.S. News, May 2, 2016.

Flossers, also known as flossettes, and flosspicks, have been abundantly available since the nineteen-seventies. They offer convenience and ease of use, but have one major drawback: they don't adequately remove the plaque and bacteria from the mouth—they simply re-distribute it. The reason is easy to understand, and intuitively, most people know it. The flosser has one short span of floss, approximately one inch in length, permanently mounted across the two legs of a plastic bow. It is that one inch of floss that has to do the work of cleaning all of the interdental spaces of the entire mouth. As soon as it is inserted into the first tooth space, the floss becomes coated with oral debris and bacteria, part of which is then delivered into the next tooth space and mixed in with the plaque and biofilm that it attempts to remove. One way to get around it would be by washing the flosspick after insertion into each tooth space. It would require having an available supply of water or standing over a sink with the water running for the duration of the flossing activity, which would effectively contravene the two main reasons for choosing the flosser over traditional flossing: convenience, and ease of use. Flossers generally are not recommended by oral hygienists as a substitute for traditional flossing.

Another interdental tool, the interproximal, or “proxy” brush, is quite popular, however, even more limited in its function. It may be useful for cleaning the larger tooth spaces near the gum line, but fails to clean the tight areas between teeth, because the core of the brush cannot be made thin enough to allow insertion. In addition, like the flosser, the brush becomes contaminated, and needs to be washed after every tooth space insertion, making the entire task tedious and inconvenient.

More recently, we have seen the appearance of various mechanized devices inaccurately named “Flossers” that contain no floss, but use water jets, and even air jets mixed with water, or mouthwash. While they claim advantage over traditional floss, they fall short in ability to remove plaque and biofilm from tooth surfaces and interdental spaces, although some may be satisfactory for washing out other oral debris, such as food, from gingival pockets in the gum line surrounding teeth.

### BRIEF SUMMARY OF THE INVENTION

In view of the foregoing disadvantages inherent in the known prior art, there exists an unmet need for an easier, more effective, more convenient, inexpensive, means of performing the routine task of interdental cleaning, one that would have great appeal and be simple and easy to use for all, including children, the elderly, and the handicapped. Therefore, it is the object of this invention to provide a new and improved method and system for interdental cleaning.

Accordingly, this invention teaches a method and system which comprises a means of interdental cleaning, said means comprising an interdental cleaning tool and washing and wetting of the active portions of the said interdental cleaning tool with an orally acceptable liquid before and after it is inserted into an interdental space for the purpose of removing accumulated debris and biofilm from the affected tooth and gum surfaces the tooth and gum surfaces with the liquid; said means provided by a pad adapted to be held in a semi-folded configuration between the thumb and fingers of one hand; said pad having an absorbent side and a barrier side; said absorbent side containing a liquid and having the ability to wash simultaneously both opposite sides of the active portions of the said interdental cleaning tool as it is held by the other hand; said pad capable of repeatedly washing and wetting the active portions of the said interdental cleaning tool throughout the tooth cleaning activity; said pad capable of holding a quantity of liquid sufficient for washing away the collected oral debris and biofilm from all interdental spaces of the mouth and diluting and absorbing the said collected oral debris and biofilm into its absorbent side; wherein an effective amount of the said liquid is transferred from the said tool onto the teeth and gums during the tooth cleaning activity; said barrier side of the said pad blocking the liquid and the collected oral debris and biofilm from the thumb and fingers of the hand holding the pad, the method and system substantially as described herein with reference to FIGS. 1, 2, 3, 2a, 2b, 2c, 2d, 4, 5, 6, 7, 8 and 9, of the accompanying drawings, and comprising the following steps:

(a) washing and wetting the active portions an interdental cleaning tool with the pad;

(b) using the interdental cleaning tool in an interdental space;

(c) repeating steps (a) and (b), as many times as desired, for all of the interdental spaces and behind the molars in the mouth.

There are several preferred embodiments to this invention. In one preferred embodiment a pad FIG. 1 as described by the foregoing and pre-wetted with a liquid is packaged together with an “F” styled flosser in a tear-open-able impermeable wrapper FIG. 4 intended for convenient, portable, disposable, inexpensive, practice of the aforementioned method.

In another preferred embodiment, a “Y” styled flosser is shown FIG. 2a.

In another preferred embodiment, a replaceable head flosser is shown FIG. 2b.

In another preferred embodiment, an interdental brush is shown FIG. 2c.

In another preferred embodiment, an interdental pick is shown FIG. 2d.

In another preferred embodiment, various interdental cleaning tools may be included, or in combination.

In another preferred embodiment, the liquid may be mouthwash.

In another preferred embodiment, the mouthwash may contain certain flavorings to appeal to individual tastes.

In another preferred embodiment, the mouthwash may contain therapeutic medicaments useful in the treatment and prevention of caries and periodontal disease.

In another preferred embodiment, the mouthwash may contain breath fresheners.

In another preferred embodiment, the mouthwash may contain tooth whitening agents.

In another preferred embodiment, the mouthwash may contain vitamins.

In another preferred embodiment, a refillable dispenser containing a quantity of pre-wetted pads in an airtight container, such as ajar with a screw top, and a quantity of interdental cleaning tools in another part of the container FIG. 5, 6.

In other preferred embodiments, various refill packages of the pads pre-wetted in various mouthwashes, with flavorings, vitamins, breath fresheners, whiteners, and medicaments, may be provided to appeal to individual needs and taste preferences.

In other preferred embodiments, dry pads may also be provided that can be wetted by the user with the liquid of their choice.

In other preferred embodiments, dry pads may also be provided that can be wetted by the user with liquid formulated to treat periodontal disease.

### BRIEF DESCRIPTION OF THE SEVERAL VIEWS OF THE DRAWINGS

The present invention will become more fully understood from the detailed description and the accompanying drawings, wherein:

FIG. 1 is a partial perspective view of the pad as it is typically held in a semi-folded position between the thumb, index, and middle fingers of the hand.

FIG. 2 is a partial perspective view with an “F” styled flosser prior to insertion into the semi-folded pad.

FIG. 3 is a partial perspective view with the “F” styled flosser inserted into the fully folded pad.

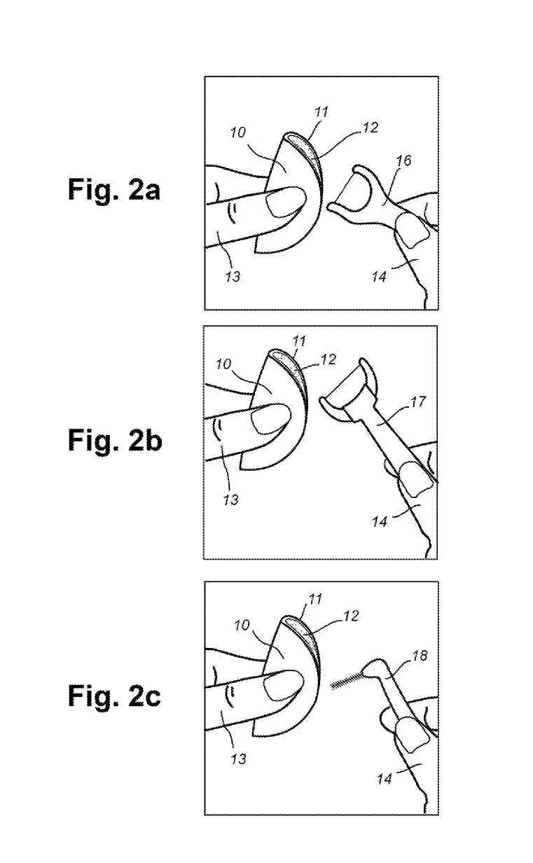

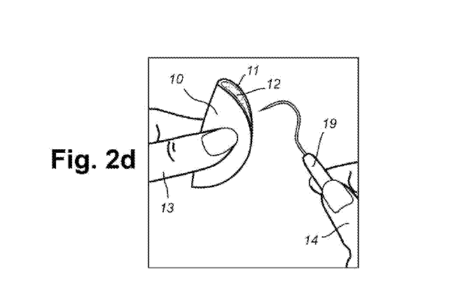

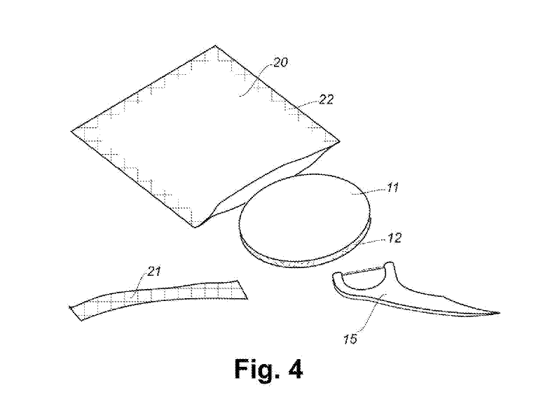

FIG. 2a is a partial perspective view with a “Y” styled flosser.

FIG. 2b is a partial perspective view with a flosser with replaceable heads.

FIG. 2c is a partial perspective view with an interdental brush.

FIG. 2d is a partial perspective view with an interdental pick.

FIG. 4 is a perspective view of an open package with a pad and “F” styled flosser.

FIG. 5 is a top view of a refillable dispenser with cutting plane A-A indicated.

FIG. 6 is a cross-sectional view A-A of the refillable dispenser.

FIG. 7 is a plan view of the circular pad.

FIG. 8 is a perspective view of the circular pad.

FIG. 9 is a plan view of the double oval pad.

### DETAILED DESCRIPTION OF THE INVENTION

While all of the interdental cleaning tools 15, 16, 17, 18, 19 described in the invention are abundant, commonplace, and readily available from myriad manufacturers and suppliers, particular attention must be paid to the materials and manufacture of the pad 10, because it is not available as an off-the-shelf item and has to meet a number of specific functional and human engineering design criteria.

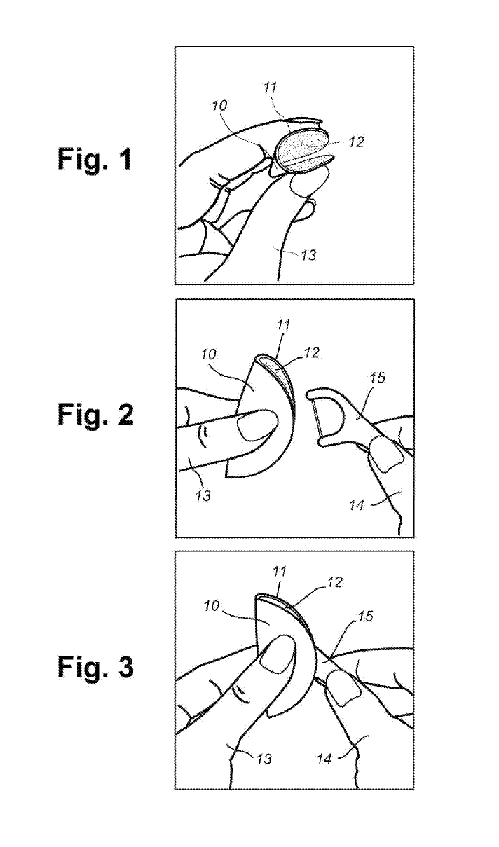

A first preferred embodiment of a pad 10 according to the invention is depicted in FIGS. 1, 2, 3, 2a, 2b, 2c, 2d, 4, 7, 8, 9, generally referred to by the reference number 10. While depicted as circular in shape, the said pad 10 can be manufactured in a variety of shapes, ranging from geometric to non-geometric, such as animal shapes, heart shapes, or other shapes, FIG. 9, for purposes of adding value in terms of product differentiation, appeal, or identity, so long as at least one axis of symmetry exists to allow for the folding of the said pad 10 into equal halves.

In the preferred embodiment a circular pad, 2.5″ dia. has been determined by testing with various interdental cleaning tools depicted in FIGS. 2, 3, 2a, 2b, 2c, 2d, and 4. A larger pad, while being functionally acceptable, would be un-necessarily wasteful of materials and detrimental to economy. A smaller pad would reduce the useful area needed to effectively provide washing and wetting of the said tools, thereby compromising effectiveness and ease of use.

In another embodiment FIG. 9, the pad shape, 2.75″×1.93″ is developed by an overlap of two ovals. This shape may be more advantageous than the circle because when folded in the tool-washing mode it is a near-oval, which is more descriptive of the actual path that the various tools are making as they are being washed. Another advantage is that such a shape has a natural fold line. Another advantage is that it uses less material than the circle. The disadvantage is that it is more costly to tool up and may require a higher degree of expertise to manufacture.

As depicted in FIGS. 1, 2, 3, 2a, 2b, 2c, 2d, 4, 7, 8, and 9, the pad 10 is comprised of a barrier layer 11 and an absorbent layer 12. The layers are bonded to each other and are substantially inseparable. The preferred bonding method is by direct application of heat and pressure, causing sufficient melting of the layers 11, 12, to permanently adhere to each other, yet not enough heat and pressure to alter the physical qualities of the layers. The process utilizes heated rollers, and is well known and widely practiced in industry.

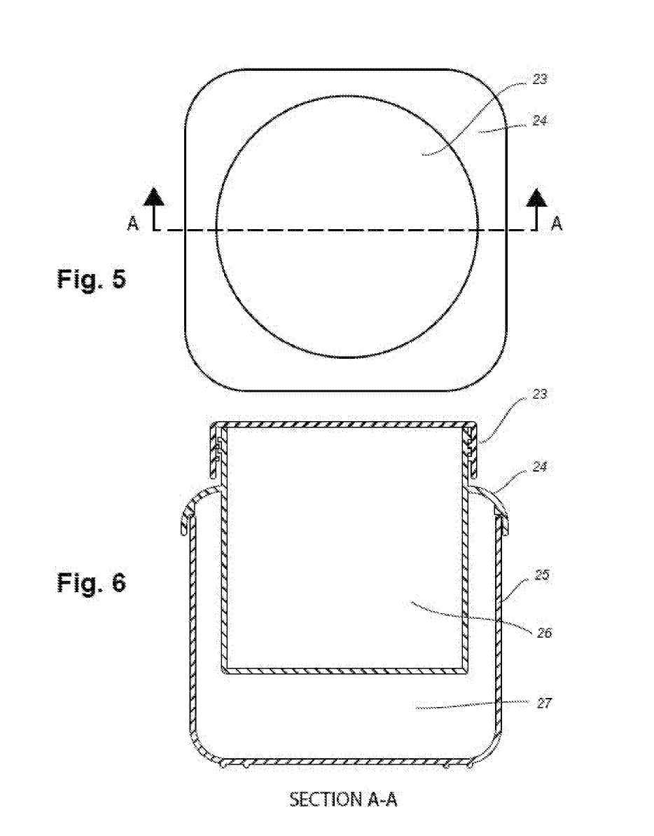

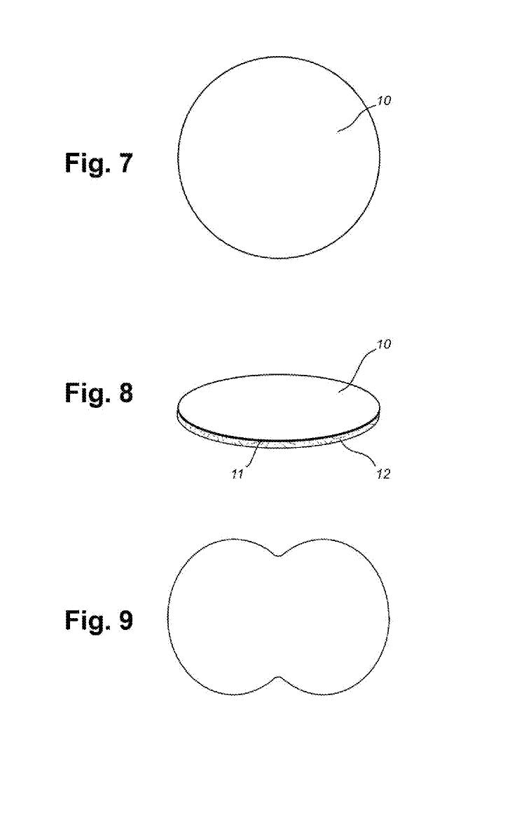

The barrier layer 11, can optionally be textured during or immediately following the bonding operation by having it pass through an additional texturing roller. The texturing of the barrier layer 11 is to enhance the function of the pad 10, by increasing the friction between the barrier layer 11, and the thumb and fingers of the holding hand 13. That is an important consideration, because friction is necessary to maintain a grasp on the pad 10 while it is held in the partially open position FIG. 1, and also when the closed pad is being used to wash the interdental cleaning tools FIG. 3.

Following the bonding of the two layers, the pad shape can be cut. In the preferred embodiment, it would be cut in a circle of 2.5″ diameter. The most common method of cutting the shapes is by die cutting. There are countless manufacturing facilities that can expertly provide this service.

In another embodiment of the pad 10 it may be desired to heat-seal the die-cut edges by using a heated die. This would effectively prevent edge fraying of the fibers of the non-woven layer 12, however, in experiments with prototypes of the invention, edge fraying was so minimal that it would not warrant the additional cost of the sealing operation. Thus in the preferred embodiment edge sealing is deemed unnecessary.

The preferred material for both the barrier layer 11, and the absorbent layer 12, is polyethylene terephthalate commonly abbreviated PET, or PETE. It is the most common thermoplastic polymer resin of the polyester family, and is widely used in fibres for clothing, containers for liquids and foods, and packaging. Even though the layers are distinctly different, the barrier layer 11 being a film, and the absorbent layer 12 being a non-woven felt, it is advantageous to have them manufactured from the same PET base material.

The first advantage of the PET materials is found in the bonding of the layers. Both the film and the felt have approximately the same melting temperature so that heat bonding of the layers can be easily controlled. Secondly, because they are chemically identical, there are no compatibility issues. Thirdly, being made from one material, the pads are recyclable, which can be a great advantage when it comes to disposal.

The barrier layer 11 is a PET film 0.5-2 mil. thick. It is available in roll form, and in a variety of thicknesses. It has superior impermeability, resistance to liquids, such as alcohol, and is food-safe. Examples are seen in medicine, beverage and liquor bottles.

The absorbent layer 12 is a PET non-woven felt approximately 0.5 mm thick with a density of 3 oz. per sq. yd. Again, the material has superior resistance to liquids, is non-allergenic, and can be stored indefinitely in a wet condition.

In addition, the felt of layer 12 may be glazed. This process involves running the felt through two heated rollers to melt back the loose fiber ends and compress the felt to smooth the surface, improving the resistance to shedding.

Although the preferred materials, as disclosed in the preceding, are various forms of PET, the inventor is concerned about the environmental impact of disposing such materials. As stated previously, the PET materials are entirely recyclable, however they are not biodegradable, meaning they have a long life in landfill and other disposal sites. There is currently a lot of activity in invention and development of biodegradable plastics that may someday replace the PET materials, thus, another preferred embodiment of the pad 10 would be that is biodegradable.

It is another advantage of the present invention that it utilizes ordinary mouthwashes as the liquids used to wash the various interdental cleaning tools. There is a great variety of mouthwashes available from many different makers. One thing that consumers can be certain of is that all of the mouthwashes are safe. Even more, all of the major branded mouthwashes have undergone many years of testing and improvement. Eliminating the need to formulate a liquid for this invention saves enormous amounts of expense, time, and regulatory issues.

The many different ingredients or additives as described in this patent are also found in many of the commercially available mouthwashes. Listerine® brand offers a wide range of formulations in their product lineup that target consumer preferences. For example, addition of essential oils like eucalyptol, menthol, methyl salicylate, and thymol has been shown to improve anti-bacterial protection and help guard against diseases like periodontitis. Adding peroxide helps whitening. Sodium fluoride helps protect teeth against cavities. There are even ingredients such as dipotassium oxalate monohydrate that help relieve dentinal hypersensitivity.

The overall function and performance of the pad 10 is dependent on the interplay of many factors, thus it should be anticipated there will be some testing needed along the way to finalizing the product.

The absorbent side of the pad 10 should be able to hold approximately 1.0 cc of liquid and none of the liquid should drip out when the pad is folded and finger pressure is applied in the tool washing operation. It is entirely possible for an overloaded pad to hold the liquid, like a sponge that is dipped in water, however some of the water would drip or gush out as soon as the sponge is squeezed. A minimal amount of testing may be needed to determine the precise amount of liquid which would satisfy that requirement. Absorbency can be adjusted, within limits, by choosing a greater or lesser denier, which is a gauge of the thickness of the fibers. Lower denier number, for example, 2.5, will produce a denser felt with more absorbency than a 3.0 denier felt. However, it will also result in a softer felt, reducing the aggressiveness of the washing surface.

The pad 10 is to be folded and held with one hand FIG. 1 between the thumb 13 and the first two fingers. It should be tested to see that the wetted pad can be easily pressed together as when it is used to wash an interdental cleaning tool FIG. 3, and be sufficiently flexible to allow the user to be able to feel the tool through the pad and be able to exert just the right amount of pressure, as one would do when cleaning eyeglass lenses with a moist napkin. Because the overall flexibility is dependent on both the barrier layer 11 and the absorbent layer 12 acting in unison, the flexibility can be adjusted to some extent by varying the weights and thicknesses of the felt layer 12 and the thicknesses of the film barrier layer 11.

The pad 10 has to be able to return itself to the semi-open position after the finger pressure is reduced, yet be able to exert sufficient resistance against the holding thumb and fingers to remain frictionally held in that position. It does not need to return to the flat condition, as some deformation can be expected after it has been folded, so long as it returns to the semi-open state. Ideally, a balance should be established where the pad is resilient enough to open, but not overly resilient, that it would create excessive resistance to the fingers and cause fatigue. Like the flexibility, the resilience can be adjusted by varying the weights and thicknesses of the felt 12 and the film backer 11.

One purpose of the barrier layer 11 is to prevent the wet absorbent layer 12 from touching the fingers. Another purpose is to enable resiliency, as described in the preceding paragraph. Another is to provide a solid surface to interface with the fingers and thumb 13. When the pre-wetted pad 10 is taken out of a package FIG. 4, or a bulk container FIG. 5, 6, the outer surface of the barrier layer 11 may initially be damp from contact with the felt layer of another pad in a package or dispenser, or from having migrated out of its own felt layer while enclosed in an individual package FIG. 4. The surface dampness of the barrier layer may be beneficial to the user because it helps the fingers and thumb 13 maintain a better grip on the pad 10. The effect may be compared to licking the fingers to help turn pages of a book or magazine or to grip a smooth object.

The stock PET film used for the barrier layer 11 has a glossy surface, making it difficult to hold the pad 10, especially in the semi-open position, because it has a tendency to slip out from the grasp of the fingers and thumb. This is even more pronounced when the pad is used to wash the active portions of an interdental tool. The friction between the tool and the absorbent layer tends to overcome the friction between the pad and fingers, resulting in the pad riding along with the tool and losing the ability to wash the tool. Texturing the PET film, as described earlier, can increase friction between the pad and fingers and overcome the internal friction between the pad and the interdental cleaning tools.

As illustrated in FIG. 1, the pre-wetted pad 10 is held in a semi-folded manner, preferably by the non-dominant hand, between the thumb 13 and first two fingers, and the interdental cleaning tool is held by the dominant hand, between the thumb 14 and the first two fingers, FIG. 2, 3, 2a, 2b, 2c, 2d. To wash the active portions of the interdental cleaning tool, the pad is closed on the tool FIG. 3 by using light finger pressure and the tool is moved in a circular fashion relative to the pad, similarly as one would clean eyeglass lenses with a folded napkin. After releasing the pressure and withdrawing the tool, the pad is allowed to return to the partially open position, as in FIG. 1, to repeat the above.

Another advantage of using the pre-wetted pad, is that the interdental cleaning tools can be re-used many times over, because the washing and germ-killing action of the mouthwash renders them clean and sterile. This can be an added convenience benefit, as well as a cost savings, further increasing the value of the invention.

By far the most popular flosser on the market, the “F” styled flosser 15 remains the most familiar, versatile, convenient, inexpensive, interdental cleaning tool. Since its appearance in the nineteen-seventies, the flosser has been vastly improved. The early versions did not have the choices of floss available, and often the floss would break at the first attempt.

Today, the floss almost never breaks, even when used repeatedly. There is a great variety of “F” styled flossers offering singe-filament, twin-filament, and even triple-filaments. Tufted floss is offered by some, touting greater cleaning power. Some flossers offer medicated and flavored floss to differentiate themselves in a crowded market.

The “Y” styled flosser 16, FIG. 2a, is another very popular version that favors cleaning the interdental spaces of the back teeth and molars. It is not quite as comfortable to use on the front teeth as the “F” styled flosser because of the angle of the handle, although many people choose them to get easier access to the back molars. There are a number of “Y” styled flossers from various manufacturers available to the consumer, all with slight design variations to appeal to different preferences.

Technically a “Y” styled flosser, the replaceable-head flosser 17 can also be used with the pre-wetted pad 10, as shown in FIG. 2b. As described earlier, the replaceable head may not need to be discarded after use and can safely be used again, saving money and the inconvenience of having to change the floss head.

In FIG. 2c, a great variety of interdental, or “proxy” brushes 18 can be used with the pre-wetted pad 10 as well, saving the inconvenience and tediousness of rinsing the brush in the sink after cleaning each interdental space. As the flossers in the preceding paragraphs, the brush can be safely put away because it will have been washed by the scrubbing action of the pad and the germicidal action of the mouthwash.

In FIG. 2d, an interdental pick is shown 19. Originally designed for professional use, various forms of the once-professional tools are now available as ordinary consumer products designed for self-administered oral hygiene.

A package containing a pre-wetted pad 10, and a flosser 15 is described FIG. 4. The flat “F” type flosser is the preferred interdental cleaning tool choice for this application, because of it small size and flat profile, however, other tools can be used as well. Among the many benefits of such a package are its low cost, small size, and convenience. It can be carried in a pocket, or pocketbook, in a glove box of a car, be taken to the office, kept in a desk drawer, put into a school locker, or back pack, or suitcase. It can be given away as free samples by restaurants, hotels, and in-store promotions. It can be sold in vending machines and checkout counter displays.

For convenience and economy the pad 10 and flosser in the oral hygiene package FIG. 4 may be re-used a few times by putting them back into the package, but the pad should not be re-used the next day. The pads should be discarded or recycled, because the PET material is recyclable.

The package is a heat-sealed high barrier film enclosure typically composed of a metallic foil sandwiched between PET films 20. The heat-seal area 22, 21, also provides for easy tear opening 21. The package is used in food, cosmetic, candy, and many other applications, including pre-wetted products, such as wet wipes.

The top part of the dispenser 23, 24, consists of a screw-top 23, and body 24, which is set into the bottom housing 25. The screw-top 23 provides an air-tight seal with the body 24 preventing the drying of the pre-wetted pads 10 stacked in the pad storage compartment 26. The interdental cleaning tools are stored in the bottom storage area 27, which is accessed by lifting out the top unit 23, 24, out of the bottom housing 25.

It will be appreciated by persons skilled in the art that the present invention is not limited to what has been particularly shown and described herein above. A variety of modifications and variations are possible without departing from the scope and spirit of the invention, which is limited only by the following claims.

What is claimed is:

1. A method and system for interdental cleaning comprising an interdental cleaning tool and a pad adapted to be held in a semi-folded configuration between the thumb and fingers of one hand, said pad having an absorbent side and a barrier side, said absorbent side containing a liquid and adapted to washing and wetting simultaneously both opposite sides of the active portions of an interdental cleaning tool, said method comprising the following steps:
(a) washing simultaneously both opposite sides of the active portions of an interdental cleaning tool with the pad;
(b) using the interdental cleaning tool in an interdental space;
(c) repeating steps (a) and (b), as many times as desired, for all of the interdental spaces and behind the molars of the mouth.

2. The method and system of claim 1, wherein the active portions consist of floss.

3. The method and system of claim 1, wherein the active portions consist of bristles.

4. The method and system of claim 1, wherein the active portions consist of picks.

5. The method and system of claim 1, wherein the interdental cleaning tool is a flosser.

6. The method and system of claim 1, wherein the interdental cleaning tool is a brush.

7. The method and system of claim 1, wherein the interdental cleaning tool is a pick.

8. The method and system of claim 1, wherein an amount of the said liquid is transferred from the active portions of the said tool onto the teeth and gums.

9. The method and system of claim 1, wherein the said liquid is mouthwash.

10. The method and system of claim 1, a package containing at least one pad that contains a liquid.

11. The method and system of claim 10, a package containing at least one pad that contains a liquid and at least one interdental cleaning tool.

12. The method and system of claim 10, a package containing at least one pad that is dry.

13. The method and system of claim 10, a package containing at least one pad that is dry and a supply of liquid.

14. The method and system of claim 10, wherein the package is a refillable dispenser.
